(19) United States
(12) Patent Application Publication
(10) Pub. No.: US 2026/0302848 A1
(43) Pub. Date: Oct. 1, 2026

(54) STATOR ASSEMBLY AND EXTERNAL-ROTOR ELECTRIC MOTOR

(71) Applicant: GUANGDONG WELLING MOTOR MANUFACTURING CO., LTD, Foshan (CN)

(72) Inventor: Tao GONG, Foshan (CN)

(21) Appl. No.: 19/467,285

(22) Filed: Feb. 2, 2026

Related U.S. Application Data
(63) Continuation of application No. PCT/CN2024/103609, filed on Jul. 4, 2024.

(30) Foreign Application Priority Data
Aug. 3, 2023 (CN) 202310978403.2

(51) Int. Cl. H02K 1/18; H02K 1/16

(52) U.S. Cl. CPC H02K 1/187; H02K 1/16

(57) ABSTRACT

An external-rotor electric motor and a stator assembly that includes a base, a sleeve, a stator core, and an insulating support are described. One end of the sleeve is connected to the base. The stator core is sleeved on the outside of the sleeve. The insulating support is connected to an end portion of the stator core facing the base. The insulating support, the sleeve, and the stator core collectively define an accommodating cavity.

### CROSS-REFERENCE TO RELATED APPLICATION

This application is a continuation-application of International (PCT) Patent Application No. PCT/CN2024/103609, filed on Jul. 4, 2024, which claims priority to Chinese Patent Application No. 202310978403.2 filed Aug. 3, 2023, and entitled “Stator Assembly and External-Rotor Electric Motor”, the entire contents of which are incorporated herein by reference.

### TECHNICAL FIELD

The present disclosure relates to the field of motors, and in particular to a stator assembly and an external-rotor electric motor.

### BACKGROUND

Motors are generally categorized into external-rotor electric motors and inner-rotor motors based on the relative positions of the rotor and the stator. The external-rotor electric motors, known for their space-saving and compact design, have attracted widespread attention. At present, the common technical method for assembling an external-rotor electric motor may involve an interference fit between the stator core and a bearing seat, which is usually achieved through cold pressing. Since the bearing seat is typically made of aluminum alloy and the stator core is made of silicon steel sheets, during the cold pressing assembly of the stator core, debris is generated as the outer surface of the bearing seat sleeve is scraped and squeezed by the stator core. Once the stator installation is completed, the debris remain inside the motor. During motor operation, the debris may adhere to the surface of the stator core or the permanent magnet segment, which may easily scratch the rotor and the stator, reduce motor efficiency, and also contribute to motor noise.

### SUMMARY

Effectively mitigate the impact of debris generated by squeezing and scraping during the assembly of the stator core on the motor may be an urgent technical problem to be solved.

The present disclosure provides a stator assembly and an external-rotor electric motor.

In some embodiments, a stator assembly, applied to an external-rotor electric motor, the stator assembly including: a base; a sleeve, with one end connected to the base; a stator core, sleeved over the sleeve; and an insulating support, connected to an end portion of the stator core facing the base, where the insulating support, the sleeve, and the stator core collectively define an accommodating cavity.

In some embodiments, the accommodating cavity is an annular cavity surrounding the sleeve.

In some embodiments, a wall surface of the stator core that defines the accommodating cavity is annular and surrounds the sleeve.

In some embodiments, the insulating support has an inner peripheral wall arranged around the sleeve. The insulating support includes a first annular flange extending from the inner peripheral wall. The first annular flange is arranged to surround and abut against an outer peripheral wall of the sleeve, such that the accommodating cavity is formed.

In some embodiments, the first annular flange is formed at an end portion of the inner peripheral wall facing away from the stator core. Alternatively, the first annular flange is located at a middle portion of the inner peripheral wall in a direction parallel to an axis of the sleeve.

In some embodiments, the sleeve includes a second annular flange arranged around the outer peripheral wall, and the second annular flange is configured to abut against the first annular flange.

In some embodiments, along an axial direction of the sleeve, the first annular flange abuts against a side of the second annular flange facing away from the stator core.

In some embodiments, along the axial direction of the sleeve, the sleeve includes a first segment connected to the stator core and a second segment connected to the insulating support. The first segment has the same diameter as the second segment, and the first annular flange abuts against a side of the second annular flange facing the stator core to locate the relative position of the stator core with respect to the sleeve.

In some embodiments, in a direction parallel to an axis of the sleeve, the first annular flange has two rings, where an outer ring is located on a side of an inner ring of the first annular flange facing away from the stator core. Alternatively, in a direction parallel to an axis of the sleeve, the outer ring of the first annular flange is located on a side of the inner ring of the first annular flange facing the stator core.

In some embodiments, the insulating support has an inner peripheral wall arranged around the sleeve, the insulating support includes a first annular flange extending from the inner peripheral wall and surrounding the sleeve, the sleeve includes a second annular flange extending from the outer peripheral wall and surrounding the outer peripheral wall, the second annular flange abuts against the first annular flange, such that the first annular flange is configured to define the accommodating cavity.

In some embodiments, along an axial direction of the sleeve, the sleeve includes a first segment connected to the stator core and a second segment connected to the insulating support, where a diameter of the first segment is smaller than a diameter of the second segment. The second segment has an annular end surface arranged around the first segment, and an end surface of the stator core facing the base abuts against the annular end surface.

In some embodiments, the annular end surface is provided with a guide groove in communication with the accommodating cavity.

In some embodiments, the sleeve has an outer peripheral wall, the sleeve includes a second annular flange extending from the outer peripheral wall and surrounding the outer peripheral wall, the second annular flange abuts against the insulating support, such that the second annular flange is configured to define the accommodating cavity.

In some embodiments, the insulating support has an inner peripheral wall arranged around the sleeve, and the second annular flange abuts against the inner peripheral wall.

In some embodiments, the sleeve has an outer peripheral wall, the sleeve includes a second annular flange extending from the outer peripheral wall and surrounding the outer peripheral wall, the second annular flange has an annular surface facing away from the base, a diameter of the annular surface gradually increases in a direction from the stator core to the base, and an end portion of the insulating support facing away from the stator core abuts against the annular surface.

In accordance with an aspect of the present disclosure, some embodiments further provide an external-rotor electric motor, including: the stator assembly of any one of the above embodiments; and a rotor assembly sleeved over an outer side of the stator assembly.

### BRIEF DESCRIPTION OF DRAWINGS

To describe the technical schemes in the embodiments of the present disclosure or the related art more clearly, the following briefly introduces the accompanying drawings required for describing the embodiments or the related art. Apparently, the accompanying drawings in the following description show merely some exemplary embodiments of the present disclosure, and a person of ordinary skill in the art may still derive other drawings from the structures shown in these accompanying drawings without creative efforts.

FIG. 1 is a schematic cross-sectional view of a stator assembly according to some embodiments of a first aspect of the present disclosure;

FIG. 2 is a schematic partially enlarged view of area A in FIG. 1;

FIG. 3 is a schematic perspective view of a base and a sleeve according to some embodiments of the present disclosure;

FIG. 4 is a schematic assembled view of a base, a sleeve, and an insulating support according to some embodiments of the present disclosure;

FIG. 5 is a schematic partially enlarged view of an accommodating cavity of a stator assembly according to some embodiments of the present disclosure;

FIG. 6 is a schematic partially enlarged view of an accommodating cavity of a stator assembly according to some embodiments of the present disclosure;

FIG. 7 is a schematic partially enlarged view of an accommodating cavity of a stator assembly according to some embodiments of the present disclosure;

FIG. 8 is a schematic partially enlarged view of an accommodating cavity of a stator assembly according to some embodiments of the present disclosure;

FIG. 9 is a schematic partially enlarged view of an accommodating cavity of a stator assembly according to some embodiments of the present disclosure;

FIG. 10 is a schematic partially enlarged view of an accommodating cavity of a stator assembly according to some embodiments of the present disclosure;

FIG. 11 is a schematic partially enlarged view of an accommodating cavity of a stator assembly according to some embodiments of the present disclosure;

FIG. 12 is a schematic partially enlarged view of an accommodating cavity of a stator assembly according to some embodiments of the present disclosure;

FIG. 13 is a schematic partially enlarged view of an accommodating cavity of a stator assembly according to some embodiments of the present disclosure;

FIG. 14 is a schematic partially enlarged view of an accommodating cavity of a stator assembly according to some embodiments of the present disclosure, where a dashed line represents a boundary between a first segment and a second segment;

FIG. 15 is a schematic partially enlarged view of an accommodating cavity of a stator assembly according to some embodiments of the present disclosure, where a dashed line represents a boundary between a first segment and a second segment;

FIG. 16 is a schematic partially enlarged view of an accommodating cavity of a stator assembly according to some embodiments of the present disclosure, where a dashed line represents a boundary between a first segment and a second segment;

FIG. 17 is a schematic partially enlarged view of an accommodating cavity of a stator assembly according to some embodiments of the present disclosure, where a dashed line represents a boundary between a first segment and a second segment; and

FIG. 18 is a schematic side view of an external-rotor electric motor according to some embodiments of a second aspect of the present disclosure.

The implementation of objectives, functional features, and advantages of the present disclosure will be further described with reference to the accompanying drawings and embodiments.

### DETAILED DESCRIPTION OF THE EMBODIMENTS

The technical schemes in the embodiments of the present disclosure will be clearly and completely described below in conjunction with the accompanying drawings in the embodiments of the present disclosure. Obviously, the described embodiments are merely some rather than all of the embodiments of the present disclosure. Based on the embodiments in the present disclosure, all other embodiments obtained by those having ordinary skills in the art without creative efforts shall fall within the scope of the present disclosure.

It should be noted that if there are directional indications, such as “up,” “down,” “left,” “right,” “front,” “rear,” and the like involved in the embodiments of the present disclosure, such directional indications are only used to illustrate the relative positional relationships, movement states, etc., among various components in a specific posture. If the specific posture changes, the directional indications shall correspondingly change accordingly.

In addition, if there are descriptions involving “first,” “second,” and the like in the embodiments of the present disclosure, such descriptions of “first,” “second,” and the like are only for descriptive purposes and shall not be construed as indicating or implying their relative importance or implicitly specifying the number of technical features indicated thereby. Thus, the features defined with “first” or “second” may explicitly or implicitly include at least one such feature. In addition, if “and/or” appears throughout the text, they shall be understood to encompass three parallel alternatives. For example, the expression “A and/or B” includes: A alone, B alone, or both A and B. Furthermore, technical schemes set forth in the various embodiments may be combined with one another, provided that such combinations can be realized by those having ordinary skills in the art. If the combination of technical schemes results in contradictions or impossibility of implementation, such combination of technical schemes shall be deemed not to exist and shall not fall within the scope defined by the present disclosure.

### LIST OF REFERENCE NUMERALS

100 - stator assembly;

110 - base;

120 - sleeve; 121 - outer peripheral wall; 122 - second annular flange; 1221 - annular surface; 123 - first segment; 124 - second segment; 1241 - annular end surface; 12411 - guide groove;

130 - stator core;

140 - insulating support; 141 - inner peripheral wall; 142 - first annular flange;

150 - accommodating cavity;

200 - external-rotor electric motor; 210 - rotor assembly.

Motors are generally categorized into external-rotor electric motors and inner rotor motors based on the relative positions of the rotor and the stator. The external-rotor electric motors, known for their space-saving and compact design, have attracted widespread attention. At present, a conventional external-rotor electric motor is equipped with two bearings, one being mounted in a bearing housing at the bottom end of the cap, and the other being placed in a bearing seat at the other end of the stator core. The rotor assembly is sleeved over an outer side of the stator assembly, with one end of the rotor shaft positioned in the central bore of the stator, such that the stator and the rotor forms a rotational fit via bearings. At present, in external-rotor electric motors, the stator core and the bearing housing are generally assembled by interference fi, which is generally achieved by cold pressing. Since the bearing seat is made of aluminum alloy and the stator core is made of a silicon steel sheet, during the assembly of the stator core by cold pressing, debris is generated as the outer surface of the bearing seat sleeve is scraped and squeezed by the stator core. Once the stator installation is completed, the debris remain inside the motor. During motor operation, the debris can adhere to the surface of the stator core or the permanent magnet segment, which may easily scratch the rotor and the stator, reduce motor efficiency, and also contribute to motor noise. In the related art, methods to address such debris—such as manual cleaning—are often inefficient and incur high time and labor costs. Alternatively, approaches like increasing the wear resistance of the sleeve material may still produce some debris and fail to effectively mitigate its impact on the motor..

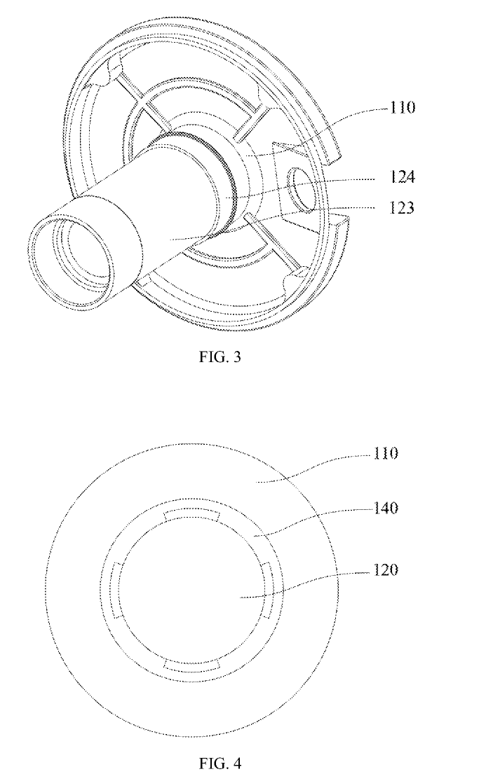

In view of this, referring to FIGS. 1-17, in accordance with a first aspect of the present disclosure, some embodiments provide a stator assembly 100, applied to an external-rotor electric motor 200. The stator assembly 100 includes a base 110, a sleeve 120, a stator core 130, and an insulating support 140.

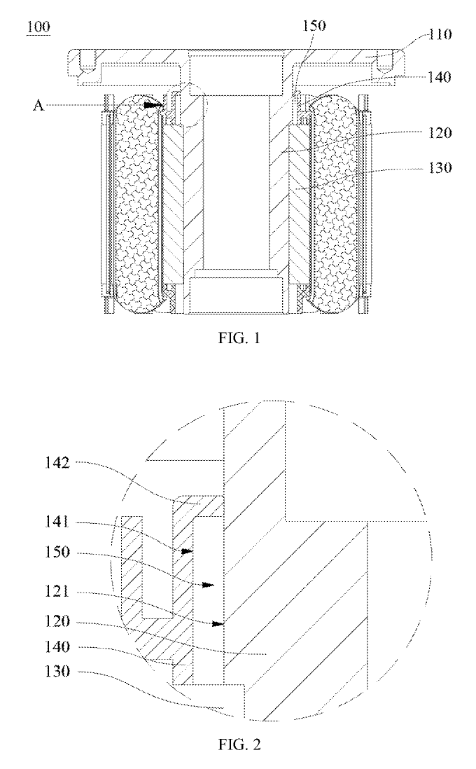

Referring to FIGS. 1-2, the base 110 may be configured to fixedly connect to the stator assembly 100. Specifically, the base 110 may be a bearing seat and is configured to connect to a bearing.

Referring to FIGS. 1-2, one end of the sleeve 120 is connected to the base 110. In different embodiments, the sleeve 120 may be fixedly or detachably connected to the base 110, or the sleeve 120 may be integrally formed with the base 110. In some embodiments, the sleeve 120 may have a through hole extending in an axial direction thereof.

Referring to FIGS. 1-2, the stator core 130 is sleeved over an outer side of the sleeve 120. It can be understood that in some embodiments, the sleeve 120 extends annularly and has an axis corresponding to an annular peripheral wall of the sleeve 120. In some embodiments, the stator core 130 may include an inner core and a plurality of independent outer core units evenly distributed along a circumferential direction of the inner core. The inner core is sleeved over the sleeve 120, and each outer core unit is connected to the inner core, thereby forming an integrated stator core 130 structure through connection elements. In addition, the stator core 130 may also be of other structures, which can be specifically referred to in the related art and will not be described here.

In some embodiments, the stator assembly 100 may further include a coil winding. The coil winding may be formed by winding of one or more wires, typically made of copper or aluminum. The shape of the winding may be circular, square, rectangular, or the like. The coil winding may be configured to be wound over the core units of the stator core 130. When power is supplied, a magnetic field is generated by the coil of the winding to drive the rotor outside the stator to start rotating.

Referring to FIGS. 1-2, the insulating support 140 is connected to an end portion of the stator core 130 facing the base 110. A main function of the insulating support 140 may be to isolate the core from the coil winding. After the insulating support 140 is connected to the stator, a coil may be wound on the insulating support 140. After the winding of the coil is completed, the wire may be terminated and the insulating support 140 may be used to assemble a finished stator assembly 100.

In some embodiments, two insulating supports 140 may be respectively arranged at two ends of the stator core 130 in its axis direction. To achieve a better insulation effect, in some embodiments, insulating paper may be provided between the core units of the stator core 130. The insulating paper may be arranged in winding slots, and the insulating supports 140 are arranged at the two ends of the stator core 130 in one-to-one correspondence. The insulating paper can insulate and isolate sidewalls of circumferentially neighboring core units from the coil winding, and the insulating support 140 can insulate and isolate the core units at the end portions from the coil winding. Thus, the insulating supports 140 and the insulating paper can collectively insulate the stator core 130 from the coil. In some other embodiments, the two insulating supports 140 at the two axial ends of the stator core 130 may further extend radially along an axis of the sleeve 120 and connect with each other, thereby wrapping and enclosing the stator core 130, so that the insulating supports 140 can provide insulation between the two end portions of the stator core 130 and slots on two sides of the stator core 130 along a circumferential direction.

Referring to FIG. 2, the insulating supports 140, the sleeve 120, and the stator core 130 collectively define an accommodating cavity 150. Specifically, in one configuration of the accommodating cavity 150, the sleeve 120 may define a wall surface of the accommodating cavity 150 on a small-diameter side relative to the axis of the sleeve 120, a wall surface of the insulating support 140 facing the sleeve 120 may define a wall surface of the accommodating cavity 150 on a large-diameter side relative to the axis of the sleeve 120, a flange of the insulating support 140 may define a top surface of the accommodating cavity 150, and the stator core 130 may define a bottom surface of the accommodating cavity 150. In other configurations of the accommodating cavity 150, the flange of the insulating support 140 and a flange of the sleeve 120 may collectively define the top surface of the accommodating cavity 150. In other embodiments, the stator core 130 and the insulating support 140 may collectively define the bottom surface of the accommodating cavity 150. In some embodiments, the top surface is a wall surface on a side of the accommodating cavity 150 away from the stator core 130, and the bottom surface is a wall surface on a side of the accommodating cavity 150 close to the stator core 130. Other configurations of the accommodating cavity 150 may be derived according to the embodiments of the present disclosure, and will not be described in detail herein. For different configurations, in some embodiments, along a circumferential direction of the axis of the sleeve 120, the accommodating cavity 150 may be a continuously extending accommodating cavity 150 or may include a plurality of discontinuously extending accommodating cavities 150.

Based on a combination of the above embodiments, referring to FIGS. 1, 2, or 3, in some embodiments, when the mounting of the insulating supports 140, the sleeve 120, and the stator core 130 is completed, the positions of these components can collectively define the accommodating cavity 150. During the press-fit assembly of the stator core 130 onto the sleeve 120, the friction between the two will lead to the formation of debris. The scattered debris may enter motor clearances, adversely affecting the operation of the motor, and leading to an increased failure rate of the motor and increased vibration and noise of the motor. During the process of mounting the stator core 130 by moving the stator core 130 toward the base 110 along the axial direction of the sleeve 120 (along a pushing direction from bottom to top in FIG. 1), debris tends to accumulate on the wall surface of the side of the stator core 130 close to the sleeve 120. Benefiting from the improvement of the solution of this application, when the insulating supports 140, the sleeve 120, and the stator core 130 are all in their installed positions, the insulating supports 140, the sleeve 120, and the stator core 130 can collectively define the accommodating cavity 150. The wall surface of the stator core 130, where debris accumulates, serves as the bottom surface of the accommodating cavity 150. Therefore, during the installation of the stator core 130 and the formation of the accommodating cavity 150, the debris is pushed into the accommodating cavity 150 along with the movement of the stator core 130. This enables the accommodating cavity 150 to effectively collect debris, preventing it from moving freely within the clearances of the motor during operation. Therefore, the stator assembly 100 of the present disclosure can significantly reduce the impact of debris formed by squeezing and scraping during the assembly of the stator core 130 on the motor, thereby improving the efficiency of the motor and reducing the vibration and noise of the motor.

Specifically, as for other configurations of the accommodating cavity 150, referring to FIGS. 1-3, in some embodiments, to enable the stator core 130 sleeved over the sleeve 120 to collect more debris, the accommodating cavity 150 may be an annular cavity surrounding the sleeve 120. It can be understood that in some embodiments, the accommodating cavity 150 extends annularly along the circumferential direction of the axis of the sleeve 120, so that the accommodating cavity 150 may extend in an annular ring. In some embodiments, the accommodating cavity 150 may extend around the sleeve 120 along the circumferential direction of the axis of the sleeve 120, and may not form a complete annular ring. For example, the accommodating cavity 150 may be an arc when viewed in the axial direction of the sleeve 120. In some embodiments, the wall surface of the stator core 130 for defining the accommodating cavity 150 may be in an annular shape surrounding the sleeve 120. It can be understood that when the accommodating cavity 150 is an annular cavity, the wall surface of the stator core 130 for defining the accommodating cavity 150 may serve as a wall surface with an opening of the accommodating cavity 150 (a wall surface through which debris is pushed into the accommodating cavity 150), and to allow more debris to be pushed into the accommodating cavity 150 during the mounting of the stator core 130, the wall surface of the stator core 130 that defines the opening of the accommodating cavity 150 may be in an annular shape surrounding the sleeve 120.

Referring to FIG. 4, in some other embodiments, along the circumferential direction of the axis of the sleeve 120, the accommodating cavity 150 may include multiple sections of discontinuously extending accommodating cavities 150. In some embodiments, opposing walls of the sleeve 120 or the insulating supports 140 may be provided with a plurality of cavities distributed at intervals, such that the multiple cavities may be used to define a plurality of discontinuously extending accommodating cavities 150. In some embodiments, the circumferential wall surface of the stator core 130 that defines the accommodating cavity 150 may enable the extension of the wall surface to align with the extension of the opening of the accommodating cavity 150. In some other embodiments, the circumferential wall surface of the stator core 130 for defining the accommodating cavity 150 may extend along in the circumferential direction by a distance greater than an extension distance of the opening of the accommodating cavity 150.

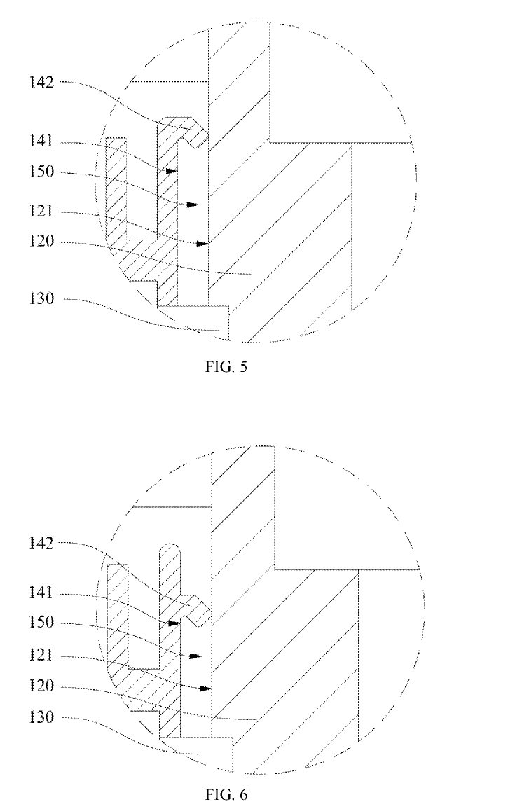

Referring to FIG. 5, in some embodiments, the insulating support 140 may have an inner peripheral wall 141 arranged around the sleeve 120. It can be understood that the inner peripheral wall 141 may be a wall surface of a side of the insulating support 140 for defining the accommodating cavity 150. The insulating support 140 includes a first annular flange 142 extending from the inner peripheral wall 141. The first annular flange 142 is arranged to surround and abut against an outer peripheral wall 121 of the sleeve 120. The outer peripheral wall 121 may be a wall surface of a side of the sleeve 120 for defining the accommodating cavity 150. The outer peripheral wall 121 and the inner peripheral wall 141 may be arranged opposite to each other along the radial direction of the axis of the sleeve 120, such that the first annular flange 142 may be configured to define the accommodating cavity 150. It can be understood that in some embodiments, the first annular flange 142 may serve as a positioning member for mounting of the insulating supports 140, a side of the first annular flange 142 facing the stator core 130 may further be configured to define the accommodating cavity 150. Referring to FIG. 5, in some embodiments, the first annular flange 142 may constitute a top surface of the accommodating cavity 150, and along the axial direction of the sleeve 120, the top surface (the wall surface of the accommodating cavity 150 opposite to the stator core 130) may be arranged opposite to the wall surface of the stator core 130 for defining the accommodating cavity 150. In other embodiments, the top surface may be defined by the first annular flange 142 alone, or may be defined collectively by the first annular flange 142 and the sleeve 120.

As for a configuration of the first annular flange 142, referring to FIG. 5, in some embodiments, the first annular flange 142 may be located at an end portion of the inner peripheral wall 141 facing away from the stator core 130. It can be understood that along the axial direction of the sleeve 120, an end portion of the insulating support 140 close to the stator core 130 may be configured to abut against or secure the stator core 130, and an end portion of the insulating support 140 away from the stator core 130 may be provided with a first annular flange 142 and be configured to define the accommodating cavity 150. Arranging the first annular flange 142 at such a position enables the accommodating cavity 150 to have a large volume to accommodate more debris. In some other embodiments, the first annular flange 142 may be located at an end portion of the inner peripheral wall 141 close to the stator core 130. Referring to FIG. 6, in some other embodiments, the first annular flange 142 may be located between two end portions of the inner peripheral wall 141 along the axial direction of the sleeve 120 (between the end portion of the inner peripheral wall 141 facing away from the stator core 130 and the end portion of the inner peripheral wall 141 close to the stator core 130). It can be understood that in some embodiments, the first annular flange 142 may be located at a middle portion of the inner peripheral wall in a direction parallel to the axis of the sleeve 120.

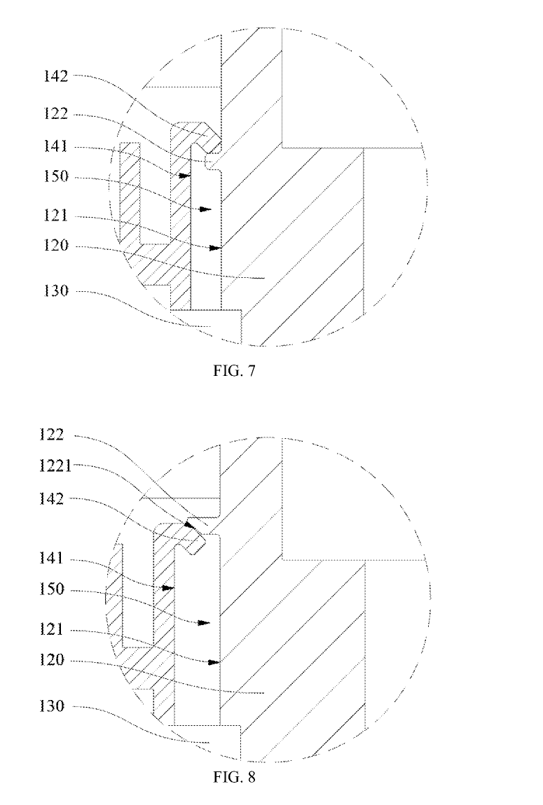

In some embodiments, the sleeve 120 may have an outer peripheral wall 121, and the sleeve 120 may include a second annular flange 122 extending from the outer peripheral wall 121 and surrounding the outer peripheral wall 121. In some embodiments, the second annular flange 122 may be used in cooperation with the first annular flange 142. Specifically, referring to FIGS. 7-8, the second annular flange 122 may abut against the first annular flange 142 to make the mounting of the insulating support 140 more reliable. Therefore, the second annular flange 122 may abut against a wall surface of one side of the first annular flange 142 or form a snap-fit connection with the first annular flange 142.

As can be seen from the above embodiments, the first annular flange 142 may abut against the second annular flange 122 to provide a secured or fixed connection. Therefore, in some embodiments, referring to FIG. 7, the first annular flange 142 may abut against the second annular flange 122 and the outer peripheral wall 121 at the same time. Referring to FIG. 8, in some other embodiments, the first annular flange 142 may abut against the second annular flange 122, but not abut against the outer peripheral wall 121. It can be understood that in some embodiments, the first annular flange 142 and the second annular flange 122 are also provided, the first annular flange 142 abuts against the second annular flange 122, and the first annular flange 142 does not abut against the outer peripheral wall 121.

As for the configuration of the second annular flange 122, referring to FIG. 7, in some embodiments, along the axial direction of the sleeve 120, the first annular flange 142 may abut against a side of the second annular flange 122 facing away from the stator core 130. The first annular flange 142 and the second annular flange 122 may abut against each other only by virtue of their mutual mounting positions, or they may be connected with each other to form a fixed structure. In some embodiments, the second annular flange 122 may limit displacement of the first annular flange 142 toward the stator core 130 along the axial direction of the sleeve 120. In some embodiments, the insulating support 140 may further have another positioning member to limit displacement of the insulating support 140 away from the stator core 130 along the axial direction of the sleeve 120.

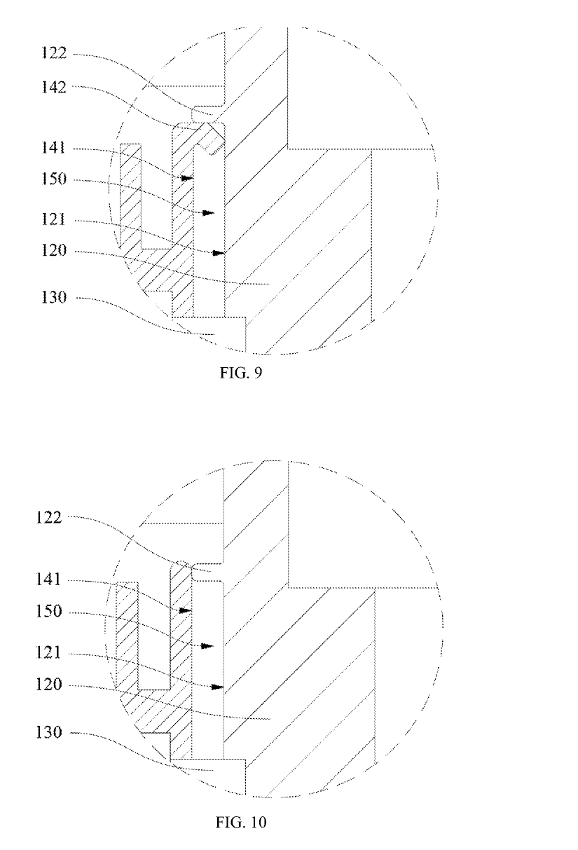

Referring to FIG. 9, in some other embodiments, along the axial direction of the sleeve 120, the first annular flange 142 may abut against a side of the second annular flange 122 close to the stator core 130. It can be understood that the arrangement of the first annular flange 142 in some embodiments is similar to that in the previous embodiments, except that the first annular flange 142 is extending from the opposite side of the second annular flange 122, and such an arrangement can limit the displacement of the first annular flange 142 away from the stator core 130 along the axial direction of the sleeve 120.

In some embodiments, the second annular flange 122 may be directly connected to a wall surface of the insulating support 140. Specifically, referring to FIG. 10, to fixedly mount the insulating support 140, the sleeve 120 may have an outer peripheral wall 121, and the sleeve 120 may include a second annular flange 122 extending from the outer peripheral wall 121 and surrounding the outer peripheral wall 121. In some embodiments, the second annular flange 122 may abut against the insulating support 140.

Referring to FIG. 10, further, in some embodiments, the insulating support 140 may have an inner peripheral wall 141 arranged around the sleeve 120. In some embodiments, the second annular flange 122 may abut against the inner peripheral wall 141. The second annular flange 122 may be configured to define the accommodating cavity 150. It can be understood that the second annular flange 122 in some embodiments is similar to the first annular flange 142, the second annular flange 122 can also serve as a positioning member for mounting of the insulating support 140, and a side of the second annular flange 122 facing the stator core 130 may also be configured to define the accommodating cavity 150. In some embodiments, the top surface of the accommodating cavity 150 may be defined by the second annular flange 122. In some embodiments, the second annular flange 122 directly abuts against the inner peripheral wall 141 of the insulating support 140, and it is not necessary to additionally provide the first annular flange 142 described above to abut against the second annular flange 122.

In a case where the sleeve 120 has an outer peripheral wall 121 and the sleeve 120 includes a second annular flange 122 extending from the outer peripheral wall 121 and surrounding the outer peripheral wall 121, referring to FIG. 8, in some embodiments, the second annular flange 122 may have an annular surface 1221 facing away from the base 110. In other words, the annular surface 1221 is located on a side of the second annular flange 122 facing the stator core 130. A diameter of the annular surface 1221 may gradually increase in a direction from the stator core 130 to the base 110. In other words, the annular surface 1221 may have a tapered slope configuration. An end portion of the insulating support 140 facing away from the stator core 130 may abut against the annular surface 1221. Referring to FIG. 8, in some embodiments, the diameter of the annular surface 1221 may gradually increase in the direction from the stator core 130 to the base 110, and the end portion of the insulating support 140 facing away from the stator core 130 may abut against the annular surface 1221. Referring to FIG. 11, in some other embodiments, the diameter of the annular surface 1221 may gradually decrease in the direction from the stator core 130 to the base 110, and an end portion of the insulating support 140 close to the stator core 130 may abut against the annular surface 1221. It can be understood that the annular surface 1221 can further tightly abut against the insulating support 140 through the tapered surface structure, to achieve a closer fit between the insulating support 140 and the annular surface 1221 (the sleeve 120) and better sealing performance of the accommodating cavity 150.

In some embodiments where the insulating support 140 includes a first annular flange 142 extending from the inner peripheral wall 141 and surrounding the sleeve 120, and the annular surface 1221 abuts against the first annular flange 142. Referring to FIG. 8, further, the first annular flange 142 may further be provided with a flange surface corresponding to the annular surface 1221. Therefore, the flange surface may be located at an end portion of the first annular flange 142 facing away from the stator core 130. The flange surface may abut against the annular surface 1221, thereby forming a contact structure in which the flange surface and the annular surface 1221 cooperate with each other.

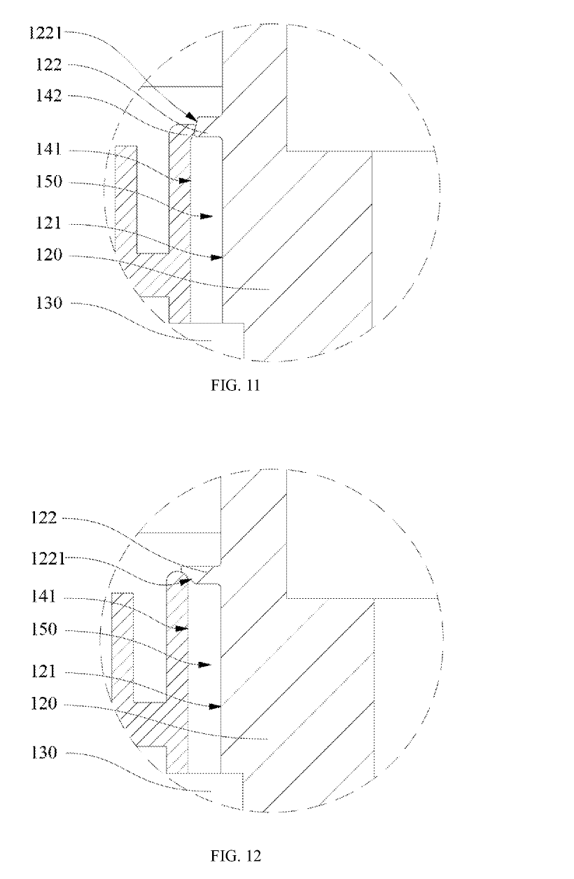

In some embodiments where the insulating support 140 does not include a flange structure, referring to FIG. 12, the annular surface 1221 may directly abut against the inner peripheral wall 141 or an end wall surface of the insulating support 140. Further, the inner peripheral wall 141 or the end wall surface may be further provided with a contact side surface corresponding to the annular surface 1221. It can be understood that the arrangement of the contact side surface is similar to that of the flange surface, except that the contact side surface is provided on the inner peripheral wall 141. Therefore, for the arrangement of the contact side surface, reference can be made to the above description, and the details will not be repeated herein.

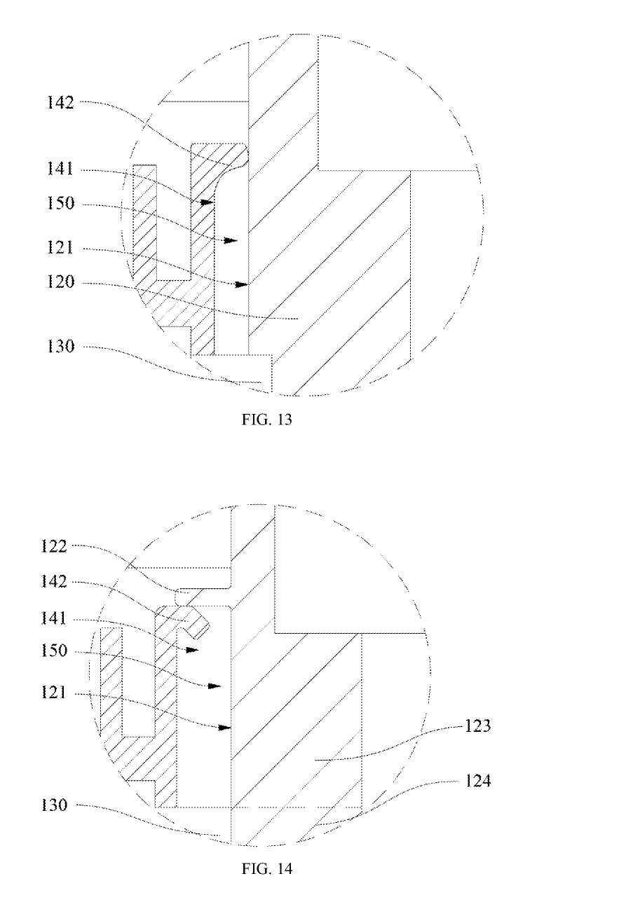

In another configuration of the first annular flange 142, it has two rings relative to the axis of the sleeve 120, i.e., an outer ring and an inner ring. It can be understood that the inner ring of the first annular flange 142 refers to an end of the first annular flange 142 close to the axis of the sleeve 120 along the radial direction of the axis of the sleeve 120, and the outer ring of the first annular flange 142 refers to an end of the first annular flange 142 away from the axis of the sleeve 120 along the radial direction of the axis of the sleeve 120. In some embodiments, the outer ring of the first annular flange 142 may be arranged staggered with respect to the inner ring in a direction parallel to the axis of the sleeve 120. Specifically, referring to FIGS. 5-9, in some embodiments, in a direction parallel to the axis of the sleeve 120, the outer ring of the first annular flange 142 may be located on a side of the inner ring facing away from the stator core 130. It can be understood that in some embodiments, each of the outer ring and the inner ring of the first annular flange 142 may be in the form of an inclined surface, with the outer ring positioned farther from the stator core 130 compared to the inner ring. Referring to FIG. 13, in some other embodiments, in a direction parallel to the axis of the sleeve 120, the outer ring of the first annular flange 142 may be located on a side of the inner ring facing the stator core 130. It can be understood that in some embodiments, each of the outer ring and the inner ring of the first annular flange 142 may be in the form of an inclined surface, with the outer ring positioned closer to the stator core 130 compared to the inner ring.

Referring to FIG. 14, along the axial direction of the sleeve 120, the sleeve 120 may include a first segment 123 connected to the stator core 130 and a second segment 124 connected to the insulating support 140. The first segment 123 has the same diameter as the second segment 124. The first annular flange 142 abuts against a side of the second annular flange 122 facing the stator core 130, to position the stator core 130 relative to the sleeve 120. It can be understood that in some embodiments, the first annular flange 142 is located at the end portion of the inner peripheral wall 141 facing away from the stator core 130, so that the first annular flange 142 can abut against the second annular flange 122 to position the insulating support 140; and the end portion of the inner peripheral wall 141 of the insulating support 140 close to the stator core 130 may abut against the stator core 130 or be provided with a connection member to connect to the stator core 130, so that the first annular flange 142 and the second annular flange 122 can collectively position the stator core 130 relative to the sleeve 120.

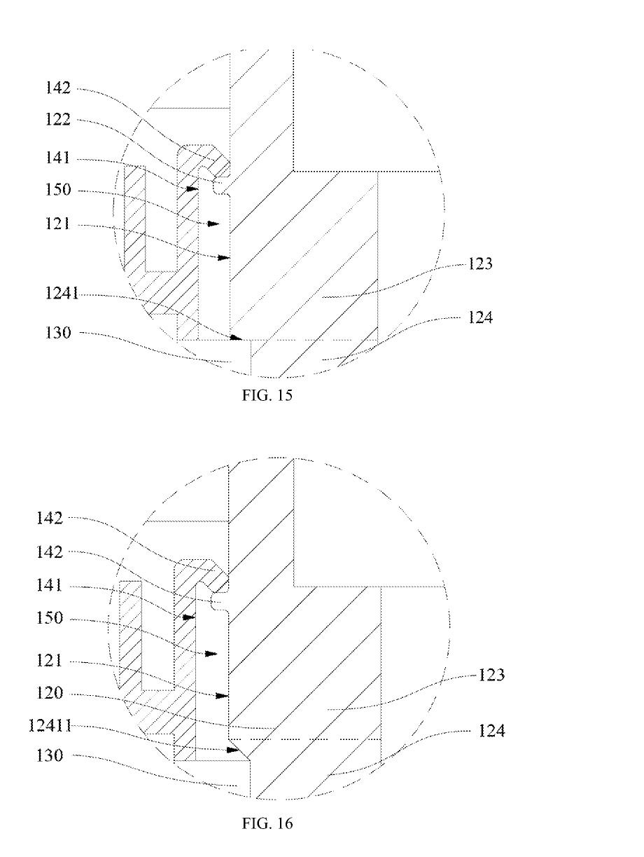

In some embodiments, along the axial direction of the sleeve 120, the sleeve 120 may include a first segment 123 connected to the stator core 130 and a second segment 124 connected to the insulating support 140. To facilitate the positioning of the stator core 130 relative to the sleeve 120, a sleeve 120 with varied segment diameters may be adopted to position the stator core 130. Referring to FIG. 15, in some embodiments, the first segment 123 and the second segment 124 have different diameters. It can be understood that the first segment 123 and the second segment 124 form a variable diameter structure of the sleeve 120 (which may also be understood as a stepped surface structure), and the stator core 130 may abut against an end surface of the first segment 123 or an end surface of the second segment 124, so that the stator core 130 can be positioned in place.

It should be noted that the first segment 123 may be connected to the second segment 124, or in different embodiments, the first segment 123 and the second segment 124 may be disconnected, with a shaft segment being connected therebetween. The first segment 123 may be fixedly or detachably connected to the second segment 124, or the first segment 123 may be integrally formed with the second segment 124.

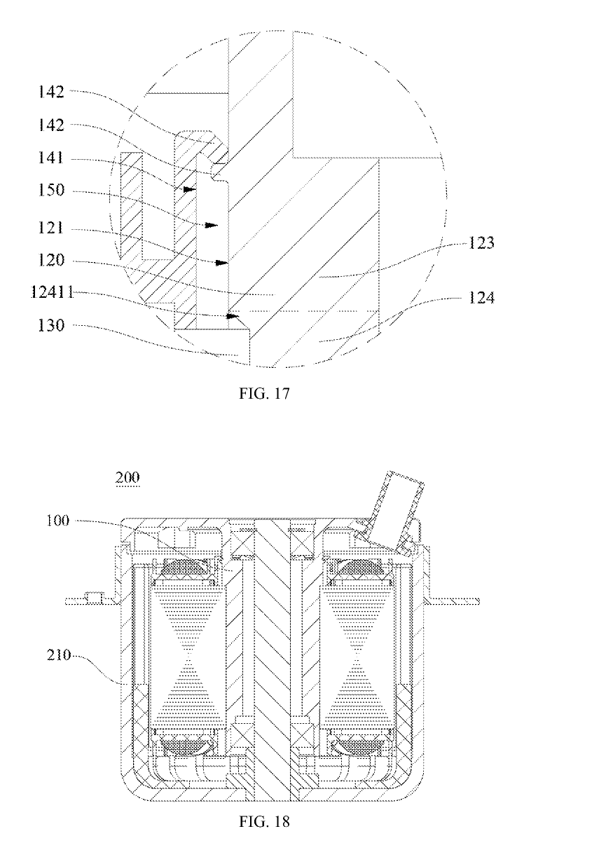

During the process of mounting the stator core 130 by moving the stator core 130 toward the base 110 along the axial direction of the sleeve 120, the wall surface of the side of the stator core 130 close to the sleeve 120 and the sleeve 120 undergo mutual squeeze and scraping, leading to the formation of debris. Consequently, the debris tends to accumulate on the wall surface of the side of the stator core 130 close to the sleeve 120, and may struggle to enter the accommodating cavity 150 smoothly. This is particularly true when the sleeve 120 has a shaft segment with varying diameters along its axial direction, as the debris is likely to accumulate on an end surface at the diameter transition point. Therefore, to facilitate the entry of more debris into the accommodating cavity 150, in some embodiments, a guide groove 12411 may be provided on either the sleeve 120 or the stator core 130. The guide groove 12411 may be in communication with the accommodating cavity 150, so that the guide groove 12411 can guide debris toward the accommodating cavity 150. Referring to FIG. 16 or FIG. 17, in some embodiments where the sleeve 120 includes a first segment 123 and a second segment 124, with the diameter of the first segment 123 being smaller than that of the second segment 124, an annular end surface 1241 of the second segment 124 may be provided with the guide groove 12411. Alternatively, the guiding groove 12411 may be provided on the first segment 123, specifically at the end of the first segment 123 near the second segment 124. In some embodiments, the guide groove 12411 may be in a form of a guide slope, and a distance between the slope of the guide groove 12411 and the axis of the sleeve 120 may gradually increase along the direction from the stator core 130 to the base 110. Referring to FIG. 16, in some embodiments, the guide groove 12411 may be an annular groove surrounding the second segment 124. Referring to FIG. 17, in some embodiments, along the circumferential direction of the axis of the sleeve 120, the guide groove 12411 may include a plurality of discontinuously extending grooves. It can be understood that since a step change in diameter is formed at the junction between the first segment 123 and the second segment 124, the guide groove 12411 on the annular end surface 1241 or on the first segment 123 facilitates channeling debris from this transition area into the accommodating cavity 150. In some other embodiments, the guide groove 12411 may be provided on the stator core 130, located near one end of the stator core 130 that contacts the sleeve 120.

Referring to FIGS. 1-18, in accordance with a second aspect of the present disclosure, some embodiments further provide an external-rotor electric motor 200. Specifically, referring to FIG. 18, the external-rotor electric motor 200 includes the stator assembly 100 of any one of the above embodiments and a rotor assembly 210. The rotor assembly 210 is sleeved over an outer side of the stator assembly 100. Benefiting from the improvements of the stator assembly 100, the external-rotor electric motor 200 of some embodiments has the same technical effects as the stator assembly 100. In addition, according to the external-rotor electric motor 200, when debris is generated within the stator assembly 100, the external-rotor electric motor 200 is capable of promptly containing and collecting it. This significantly reduces the amount of debris that may migrate into other components, such as the rotor assembly 210. Consequently, the adverse impact of debris on the external-rotor electric motor 200 is effectively minimized, contributing to enhanced motor efficiency and reduced vibration and noise.

The above descriptions are merely preferred embodiments of the present disclosure, and are not intended to limit the scope of the present disclosure. Any equivalent structural transformation made based on the contents of the specification and drawings of the present disclosure, or the direct or indirect application of the present disclosure to other related technical fields without departing from the knowledge of the present disclosure are all included in the scope of the present disclosure.

What is claimed is:

1. A stator assembly for an external-rotor electric motor, comprising:
a base;
a sleeve, one end of which is connected to the base;
a stator core, sleeved over the sleeve; and
an insulating support, connected to an end portion of the stator core facing the base,
wherein the insulating support, the sleeve, and the stator core collectively define an accommodating cavity.

2. The stator assembly of claim 1, wherein the accommodating cavity is an annular cavity surrounding the sleeve.

3. The stator assembly of claim 1, wherein the stator core has a wall surface defining the accommodating cavity, and the wall surface is in an annular shape surrounding the sleeve.

4. The stator assembly of claim 1, wherein the insulating support has an inner peripheral wall arranged around the sleeve, the insulating support comprises a first annular flange extending from the inner peripheral wall and surrounding the sleeve, the first annular flange abuts against an outer peripheral wall of the sleeve, and the first annular flange is configured to define the accommodating cavity.

5. The stator assembly of claim 4, wherein:
the first annular flange is located at an end portion of the inner peripheral wall facing away from the stator core; or
the first annular flange is located at a middle portion of the inner peripheral wall in a direction parallel to an axis of the sleeve.

6. The stator assembly of claim 4, wherein the sleeve comprises a second annular flange extending from the outer peripheral wall and surrounding the outer peripheral wall, and the second annular flange abuts against the first annular flange.

7. The stator assembly of claim 6, wherein along an axial direction of the sleeve, the first annular flange abuts against a side of the second annular flange facing away from the stator core.

8. The stator assembly of claim 7, wherein along the axial direction of the sleeve, the sleeve comprises a first segment connected to the stator core and a second segment connected to the insulating support, the first segment has the same diameter as the second segment, and the first annular flange abuts against a side of the second annular flange facing the stator core to position the stator core relative to the sleeve.

9. The stator assembly of claim 4, wherein:
the first annular flange has an outer ring and an inner ring,
in a direction parallel to an axis of the sleeve, the outer ring of the first annular flange is located on a side of the inner ring of the first annular flange facing away from the stator core; or
in a direction parallel to an axis of the sleeve, the outer ring of the first annular flange is located on a side of the inner ring of the first annular flange facing the stator core.

10. The stator assembly of claim 1, wherein the insulating support has an inner peripheral wall arranged around the sleeve, the insulating support comprises a first annular flange extending from the inner peripheral wall and surrounding the sleeve, the sleeve comprises a second annular flange extending from an outer peripheral wall and surrounding the outer peripheral wall, the second annular flange abuts against the first annular flange, and the first annular flange is configured to define the accommodating cavity.

11. The stator assembly of claim 1, wherein along an axial direction of the sleeve, the sleeve comprises a first segment connected to the stator core and a second segment connected to the insulating support, a diameter of the first segment is smaller than a diameter of the second segment, the second segment has an annular end surface arranged around the first segment, and an end surface of the stator core facing the base abuts against the annular end surface.

12. The stator assembly of claim 11, wherein the annular end surface is provided with a guide groove in communication with the accommodating cavity.

13. The stator assembly of claim 1, wherein the sleeve has an outer peripheral wall, the sleeve comprises a second annular flange extending from the outer peripheral wall and surrounding the outer peripheral wall, the second annular flange abuts against the insulating support, and the second annular flange is configured to define the accommodating cavity.

14. The stator assembly of claim 13, wherein the insulating support has an inner peripheral wall arranged around the sleeve, and the second annular flange abuts against the inner peripheral wall.

15. The stator assembly of claim 1, wherein the sleeve has an outer peripheral wall, the sleeve comprises a second annular flange extending from the outer peripheral wall and surrounding the outer peripheral wall, the second annular flange has an annular surface facing away from the base, a diameter of the annular surface gradually increases in a direction from the stator core to the base, and an end portion of the insulating support facing away from the stator core abuts against the annular surface.

16. An external-rotor electric motor, comprising:
the stator assembly of claim 1; and
a rotor assembly sleeved over an outer side of the stator assembly.
